(19) United States
(12) Patent Application Publication
(10) Pub. No.: US 2024/0095205 A1
(43) Pub. Date: Mar. 21, 2024

(54) User-defined peripheral-bus device implementation

(71) Applicant: MELLANOX TECHNOLOGIES, LTD., Yokneam (IL)

(72) Inventors: Daniel Marcovitch, Yokneam Illit (IL); Liran Liss, Atzmon-Segev (IL); Aviad Shaul Yehezkel, Yokneam Illit (IL); Rabia Loulou, Nazareth (IL); Oren Duer, Kohav Yair (IL); Shahaf Shuler, Kibbutz Lohamei Hagetaot (IL); Chenghuan Jia, Fremont, CA (US); Philip Browning Johnson, Los Gatos, CA (US); Gal Shalom, Givat Avni (IL); Omri Kahalon, Yehud (IL); Adi Merav Horowitz, Tel Aviv (IL); Arpit Jain, Pune (IN); Eliav Bar-Ilan, Or Akiva (IL); Prateek Srivastava, San Jose, CA (US)

(21) Appl. No.: 17/987,904

(22) Filed: Nov. 16, 2022

(30) Foreign Application Priority Data
Sep. 15, 2022 (IN) 202241052839

(51) Int. Cl. G06F 13/42; G06F 13/40

(52) U.S. Cl. CPC G06F 13/4221; G06F 13/4022; G06F 13/404

(57) ABSTRACT

A system includes a bus interface and circuitry. The bus interface is configured to communicate with an external device over a peripheral bus. The circuitry is configured to support a plurality of widgets that perform primitive operations used in implementing peripheral-bus devices, to receive a user-defined configuration, which specifies a user-defined peripheral-bus device as a configuration of one or more of the widgets, and to implement the user-defined peripheral-bus device toward the external device over the peripheral bus, in accordance with the user-defined configuration.

### FIELD OF THE INVENTION

The present invention relates generally to computing systems, and particularly to methods and systems for user-defined implementation of peripheral-bus devices.

### BACKGROUND OF THE INVENTION

Computing systems often use peripheral buses for communication among processors, memories and peripheral devices. Examples of peripheral buses include Peripheral Component Interconnect express (PCIe), Compute Express Link (CXL) bus, NVLink and NVLink-C2C. Peripheral devices may comprise, for example, network adapters, storage devices, Graphics Processing Units (GPUs) and the like.

### SUMMARY OF THE INVENTION

An embodiment of the present invention that is described herein provides a system including a bus interface and circuitry. The bus interface is configured to communicate with an external device over a peripheral bus. The circuitry is configured to support a plurality of widgets that perform primitive operations used in implementing peripheral-bus devices, to receive a user-defined configuration, which specifies a user-defined peripheral-bus device as a configuration of one or more of the widgets, and to implement the user-defined peripheral-bus device toward the external device over the peripheral bus, in accordance with the user-defined configuration.

In some embodiments, the external device is a host, or a peer device coupled to the host. In various embodiments, the user-defined peripheral-bus device is one of a network adapter, a storage device, a Graphics Processing Unit (GPU), and a Field Programmable Gate Array (FPGA). In a disclosed embodiment, the circuitry is configured to implement the user-defined peripheral-bus device by software emulation.

In some embodiments, the widgets are configured to be invoked by the external device accessing respective addresses that are assigned to the implemented user-defined peripheral-bus device in an address space of the peripheral bus. In an example embodiment, the address space includes a configuration space, and the circuitry includes a handler for handling accesses of the external device to the configuration space that configure the implemented user-defined peripheral-bus device.

In an embodiment, the address space includes a memory space, and the circuitry is configured to invoke the widgets in response to the external device accessing addresses in the memory space. In an embodiment, the address space includes an Input/Output (I/O) space, and the circuitry is configured to invoke the widgets in response to the external device accessing addresses in the I/O space. In an alternative embodiment, the widgets are configured to be invoked by the external device accessing one or more message types over the peripheral bus.

In another embodiment, the circuitry is configured to access a memory of the external device on behalf of the implemented user-defined peripheral-bus device in accordance with the user-defined configuration. In yet another embodiment, the circuitry is configured to issue interrupts on the peripheral bus on behalf of the implemented user-defined peripheral-bus device, in accordance with the user-defined configuration.

In some embodiments, the circuitry includes (i) user-defined peripheral-bus device implementation (UDDI) hardware and (ii) a processor that runs user-defined peripheral-bus device implementation (UDDI) software; and a given widget is configured to perform a primitive operation by (i) performing a front-end part of the primitive operation using the UDDI hardware, and (ii) triggering the UDDI software to perform a back-end part of the primitive operation. In an example embodiment, the UDDI hardware is configured to issue an event to the UDDI software upon completing the front-end part of the primitive operation, and the UDDI software is configured to update a state of the given widget upon completing the back-end part of the primitive operation.

In various embodiments, the circuitry includes a configurable semaphore for enabling a first widget to lock and release a second widget in accordance with the user-defined configuration. In an example embodiment, the first widget and the second widget are the same widget. In an embodiment the semaphore is releasable by software or hardware.

In an example embodiment, the circuitry includes a hardware accelerator configured to accelerate the widgets of a given type. In a disclosed embodiment, at least a given widget is specified in terms on one or more other widgets in the plurality.

In various embodiments, the widgets include one or more of the following widget types—a passthrough widget that forwards a transaction packet received over the peripheral bus for handling by software, a widget implementing a doorbell, a widget implementing a work request, a read-only widget, a write-only widget, a read-write widget, and a write-combine widget.

There is additionally provided, in accordance with an embodiment that is described herein, a method including communicating with an external device over a peripheral bus, and supporting a plurality of widgets that perform primitive operations used in implementing peripheral-bus devices. A user-defined configuration, which specifies a user-defined peripheral-bus device as a configuration of one or more of the widgets, is received. The user-defined peripheral-bus device is implemented toward the external device over the peripheral bus, in accordance with the user-defined configuration.

The present invention will be more fully understood from the following detailed description of the embodiments thereof, taken together with the drawings in which:

### BRIEF DESCRIPTION OF THE DRAWINGS

FIGS. 1A and 1B are block diagrams that schematically illustrate computing systems employing user defined peripheral-bus device implementation (UDDI), in accordance with embodiments of the present invention;

FIGS. 2A-2D are block diagrams that schematically illustrate UDDI configurations, in accordance with embodiments of the present invention;

FIGS. 3A-3C are block diagrams that schematically illustrate configurations for UDDI of multiple sub-devices, in accordance with embodiments of the present invention;

FIG. 4 is a block diagram of a computing system employing UDDI, focusing on the internal structure of a generic UDDI mechanism, in accordance with an embodiment of the present invention;

FIG. 5 is a block diagram of a computing system employing UDDI, focusing on widget structure and usage, in accordance with an embodiment of the present invention; and

FIG. 6 is a flow chart that schematically illustrates a method for UDDI, in accordance with an embodiment of the present invention.

### DETAILED DESCRIPTION OF EMBODIMENTS

### Overview

Embodiments of the present invention that are described herein provide improved methods and systems for user-defined implementation of peripheral devices in computing systems. In the disclosed embodiments, a user defined peripheral-bus device implementation (UDDI) system provides users with a generic framework for specifying user-defined peripheral devices.

Peripheral devices that can be specified and implemented using the disclosed techniques include, for example, network adapters (e.g., Network Interface Controllers—NICs), storage devices (e.g., Solid State Drives—SSDs), Graphics Processing Units (GPUs) and Field-Programmable Gate Arrays (FPGAs). UDDI may be performed over various types of peripheral buses, e.g., Peripheral Component Interconnect express (PCIe), Compute Express Link (CXL) bus, NVLink and NVLink-C2C.

In some embodiments, once a user-defined peripheral device has been specified and configured, the UDDI system exposes over the peripheral bus an interface that appears to a user application as a dedicated, local peripheral device. The actual peripheral device, however, may be located remotely from the computing system running the user application, shared by one or more other user applications and/or designed to use a different native interface than the user application, or emulated entirely using software. Thus, in general, user-defined implementation of a peripheral device may involve accessing local devices, communication over a network with remote devices, as well as protocol translation.

In the present context, emulation of a device using user-defined software is considered a special case of user-defined implementation of a device. Some embodiments described herein refer to emulation, by way of example, but the disclosed techniques can be carried out using other sorts of user-defined implementation, e.g., using a combination of hardware and software.

In some embodiments, the UDDI system takes advantage of the fact that many basic primitive operations are common to various kinds of peripheral devices. The UDDI system provides users with (i) a pool of widgets that that perform such primitive operations, and (ii) an Application Programming interface (API) for configuring the business logic of the desired peripheral device in terms of the widgets. The UDDI system then implements (e.g., emulates) the peripheral device in accordance with the user-defined configuration.

In the present context, the term “primitive operation” refers to a basic hardware and/or software operation that is commonly used as a building block in implementing peripheral-bus devices. A primitive operation may comprise a computation, an interface-related operation, a data-transfer operation, or any other suitable operation. The term “widget” refers to a user-configurable hardware and/or software element that implements one or more primitive operations.

In some embodiments, the widgets are implemented using a combination of hardware and software. The hardware typically carries out tasks that are closer to the peripheral bus. The software typically carries out more complex, backend tasks. Relatively simple widgets may be implemented using hardware only. The widgets are typically invoked by the user application accessing designated addresses over the peripheral bus.

It is noted that the term “user” may refer to various entities, whether individuals or organizations. For example, in a given system, a user-defined peripheral device may be specified by one “user” but accessed by (interfaced with) by a different “user”. For example, the user specifying the user-defined peripheral device may be an infrastructure owner, whereas the user using the user-defined peripheral device may be a consumer. In a cloud environment, for example, the former user would be a Cloud Service Provider (CSP) and the latter user could be a guest or tenant. In some cases, however, a user-defined peripheral device may be specified and used by the same user.

Various example configurations of the UDDI system, examples of widgets, and examples of specifying user-defined peripheral devices using widgets, are described herein.

The methods and systems described herein enable users a high degree of flexibility in specifying peripheral devices by a user. By carrying out at least some of the UDDI tasks on a separate platform, the disclosed techniques offload the host processor of such tasks, and also provide enhanced security and data segregation between different users.

### System Description

In some embodiments of the present invention, a UDDI system comprises three major components—(i) a user platform, (ii) a UDDI platform and (iii) a generic UDDI mechanism. In the context of the present disclosure and in the claims, the combination of these components is referred to as “circuitry” that carries out the disclosed techniques. In various embodiments, the circuitry may be implemented using hardware and/or software as appropriate. Typically, although not necessarily, the generic UDDI mechanism component is implemented in hardware, while the user platform and the UDDI platform comprise processors that run software. The task partitioning among internal components of the circuitry may vary from one implementation to another.

The UDDI system thus typically comprises a bus interface and circuitry. The bus interface communicates with an external device (e.g., a host or a peer device coupled to the host) over a peripheral bus. The circuitry supports a plurality of widgets, receives a user-defined configuration that specifies a user-defined peripheral-bus device in terms of one or more of the widgets, and implements (e.g., emulates) the user-defined peripheral-bus device toward the external device over the peripheral bus, in accordance with the user-defined configuration.

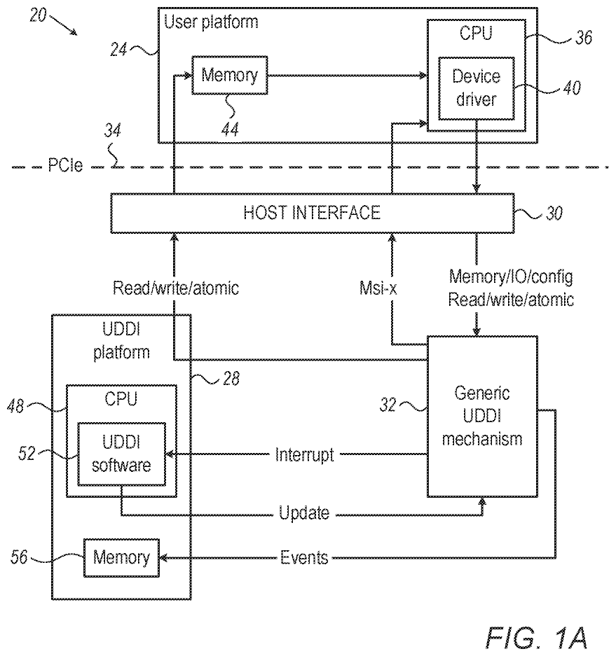

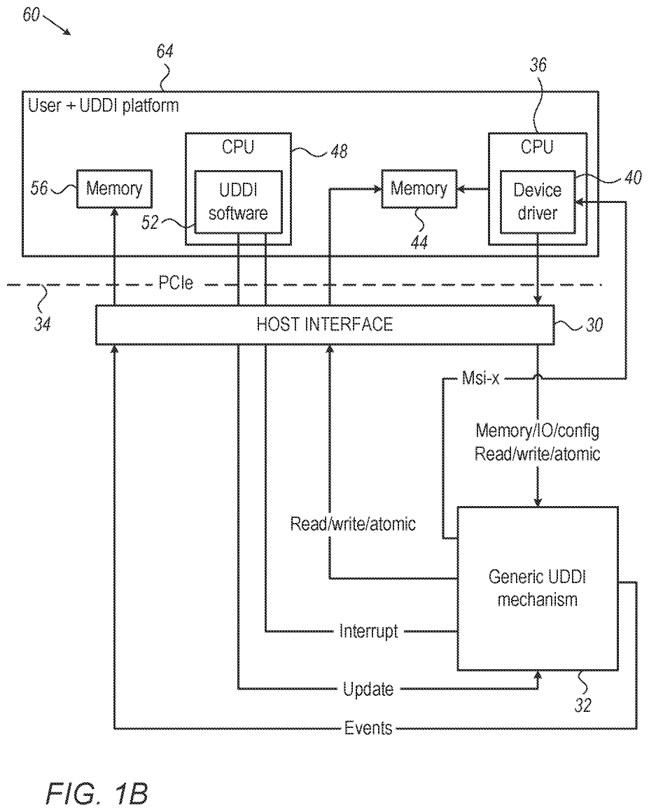

FIG. 1A is a block diagram that schematically illustrates a computing system 20 employing UDDI, in accordance with an embodiment of the present invention. In the embodiment of FIG. 1A, the user platform and the UDDI platform are implemented on separate computing platforms, and the UDDI mechanism is exposed over the peripheral bus. In one possible implementation, the UDDI platform and UDDI mechanism both reside on a “SmartNIC” (also referred to as Data Processing Unit—DPU) that serves the user platform.

System 20 of FIG. 1A comprises a user platform 24, a UDDI platform 28, a generic UDDI mechanism 32, and a host interface 30. In the present example, UDDI mechanism 32 and UDDI platform 28 communicate with user platform 24 over a peripheral bus 34 via host interface 30. Host interface 30 is thus also referred to as a bus interface. Bus 34 in the present embodiment is a PCIe bus. Alternatively, bus 34 may comprise a CXL bus, an NVLink bus, an NVLink-C2C bus, or any other suitable peripheral bus. UDDI mechanism 32 is sometimes referred to herein as “UDDI hardware” (although in some embodiments some of its functionality may be implemented in software).

User platform 24 comprises a Central Processing Unit (CPU) 36, which is also referred to as a host. CPU 36 runs user applications (not shown in the figure) and also runs a device driver 40 of the UDDI system. User platform 44 further comprises a memory 44, e.g., a Random-Access Memory (RAM). Memory 44, also referred to as a host memory, may be accessed directly by device driver 40, and also over bus 34 by UDDI mechanism 32 and/or UDDI platform 28. In some embodiments, a peer device (e.g., GPU or FPGA) may be coupled to user platform 24.

UDDI platform 28 comprises a CPU 48 and a memory 56, e.g., a RAM. CPU 48 runs UDDI software 52. Memory 56 may be accessed by UDDI software 52, and/or directly by UDDI mechanism 32.

UDDI mechanism 32 comprises a pool of widgets that are used as building blocks for specifying user-defined peripheral devices. UDDI mechanism 32 exposes basic peripheral-device functionality toward device driver 40 over bus 34. The basic device functionality includes configuration-space, memory-space and I/O-space access. UDDI mechanism 32 interacts with UDDI software 52 for completing the device implementation.

The interfaces between user platform 24 and UDDI mechanism 32 (over bus 34) comprise (i) memory access operations from CPU 36 to designated addresses in UDDI mechanism 32, (ii) Message Signaled Interrupts (MSI-X) issued from UDDI mechanism 32 to CPU 36, (iii) direct memory accesses from UDDI mechanism 32 to host memory 44, and (iv) PCIe messages.

The interface between UDDI mechanism 32 and UDDI software 52 comprises (i) interrupts or events issued from UDDI mechanism 32 to CPU 48, and (ii) updates (e.g., state updates) from UDDI software 52 to UDDI mechanism 32.

FIG. 1B is a block diagram that schematically illustrates a computing system 60 employing UDDI, in accordance with an alternative embodiment of the present invention. In this embodiment, user platform 24 and UDDI platform 28 are implemented on a single computing platform 64, and UDDI mechanism 32 is exposed over peripheral bus 34 (e.g., logically attached to a hypervisor running on CPU 36).

The system configurations seen in FIGS. 1A and 1B are example configurations that are chosen purely for the sake of conceptual clarity. In alternative embodiments, any other suitable system configuration can be used. For example, UDDI platform 28 may be embedded, in whole or in part, in generic UDDI mechanism 32. As another example, user platform 24 and UDDI platform 28 may be implemented on separate computing platform, each having a separate PCIe link. As yet another example, UDDI software 52 may be split into a first part that is closely coupled to UDDI mechanism 32, and a second part that is closely coupled to device driver 40 (across the PCIe bus from the first part). A suitable software protocol connects the two parts.

### Device Types and UDDI Configurations

In various embodiments, the disclosed techniques can be used for implementing any suitable peripheral device, e.g., network adapters, storage devices that support various storage protocols, GPUs, FPGAs, etc.

User-defined (e.g., emulated) storage devices may support various storage protocols, e.g., Non-Volatile Memory express (NVMe), block-device protocols such as virtio-blk, local or networked file systems, object storage protocols, network storage protocols, etc. Further aspects of device emulation are addressed, for example, in U.S. patent application Ser. No. 17/211,928, entitled “Storage Protocol Emulation in a Peripheral Device,” filed Mar. 25, 2021, in U.S. patent application Ser. No. 17/372,466, entitled “Network Adapter with Efficient Storage-Protocol Emulation,” filed Jul. 11, 2021, and in U.S. patent application Ser. No. 17/527,197, entitled “Enhanced Storage Protocol Emulation in a Peripheral Device,” filed Nov. 16, 2021, which are assigned to the assignee of the present patent application and whose disclosures are incorporated herein by reference.

In various embodiments, the disclosed UDDI system may expose a single device type (e.g., storage, network, GPU, etc.) or multiple device types. Multiple device types may be exposed as separate devices or as separate bus functions. A given device may expose multiple physical and/or virtual functions of the same device type. Multiple devices may be exposed over multiple logical PCIe links, or behind an emulated PCIe switch.

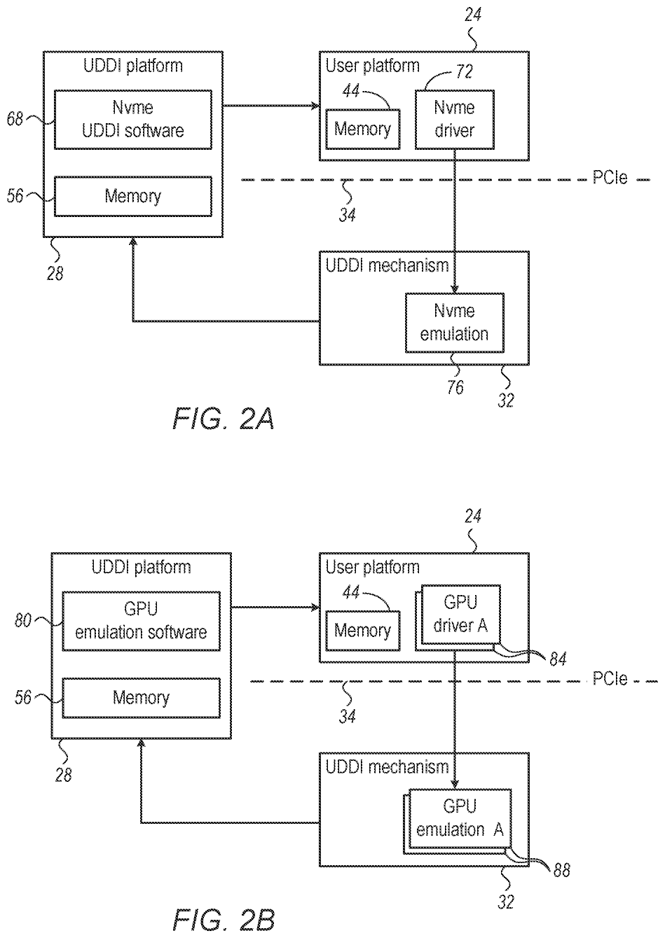

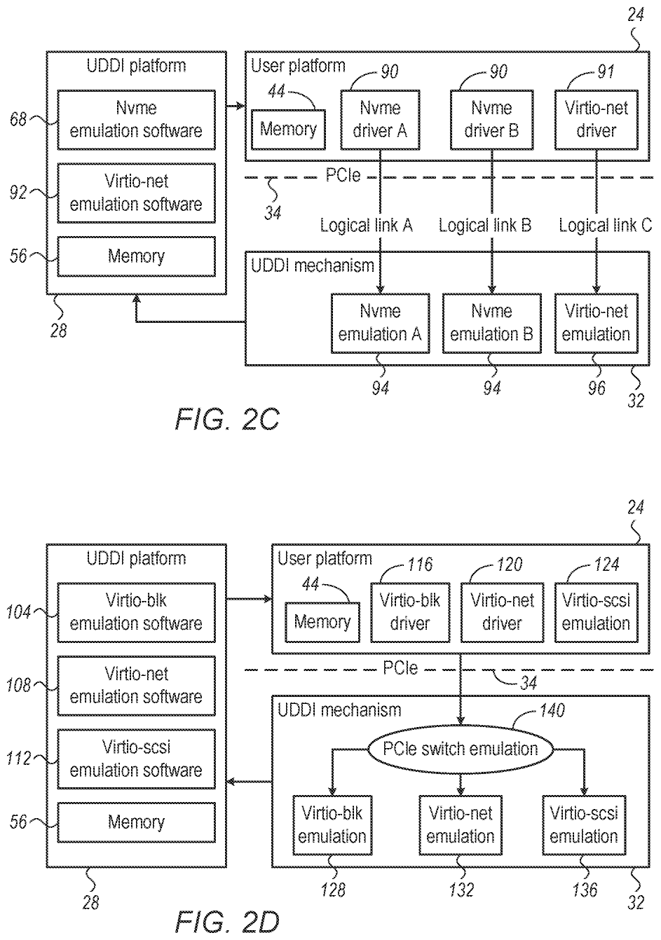

FIGS. 2A-2D are block diagrams that schematically illustrate UDDI configurations, in accordance with embodiments of the present invention.

In FIG. 2A, the UDDI system emulates a single NVMe storage device (e.g., NVMe SSD). In this embodiment, user platform 24 runs an NVME driver 72, UDDI platform 28 runs NVMe UDDI software 68, and UDDI mechanism 32 comprises an NVME emulation mechanism 76.

In FIG. 2B, the UDDI system implements a single device (e.g., a GPU), or multiple devices of the same device type (in the present example GPUs), using multiple physical functions. In this embodiment, user platform 24 runs multiple GPU drivers 84, UDDI platform 28 runs GPU emulation software 80, and UDDI mechanism 32 comprises multiple GPU emulation mechanisms 88.

In FIG. 2C, the UDDI system emulates multiple devices of different device types, in the present example two NVMe devices and one virtio-net device. In this embodiment, user platform 24 runs two NVME drivers 90 and a virtio-net driver 92, UDDI platform 28 runs NVME emulation software 68 and virtio-net emulation software 92, and UDDI mechanism 32 comprises two NVME emulation mechanisms 94 and a virtio-net emulation mechanism 96.

In FIG. 2D, the UDDI system implements multiple devices of different device types, in the present example a virtio-blk device, a virtio-net device and a virtio-scsi device. In the embodiment of FIG. 2D, in contrast to FIG. 2C, the multiple devices are exposed using an emulated PCIe switch. In this embodiment, user platform 24 runs a virtio-blk driver 116, a virtio-net driver 120 and a virtio-scsi driver 124. UDDI platform 28 runs virtio-blk emulation software 104, virtio-net emulation software 108, and virtio-scsi emulation software 112.

UDDI mechanism 32 comprises a virtio-blk emulation mechanism 128, a virtio-scsi emulation mechanism 132, and a virtio-net emulation mechanism 136. UDDI mechanism 32 further comprises PCIe switch emulation circuitry, which emulates a PCIe switch that exposes emulation mechanisms 128, 132 and 136 over PCIe bus 34.

In some embodiments, when implementing (e.g., emulating) a given device, the emulation also supports multiple sub-devices. Sub-devices may be exposed under different PCIe functions. In such an implementation, host isolation can be guaranteed since PCIe transactions of different sub-devices are identified under different requestor IDs or other mechanisms. Alternatively, sub-devices may be exposed under a single PCIe function. In these embodiments, host isolation can be guaranteed by using different Process Address Space Ids (PASIDs) or other mechanisms. In both cases, PCIe transactions received by the user-defined device can be associated with the appropriate sub-device due to address space separation. Sub-devices of the same device typically have similar inbound I/O-space and memory-space handling properties.

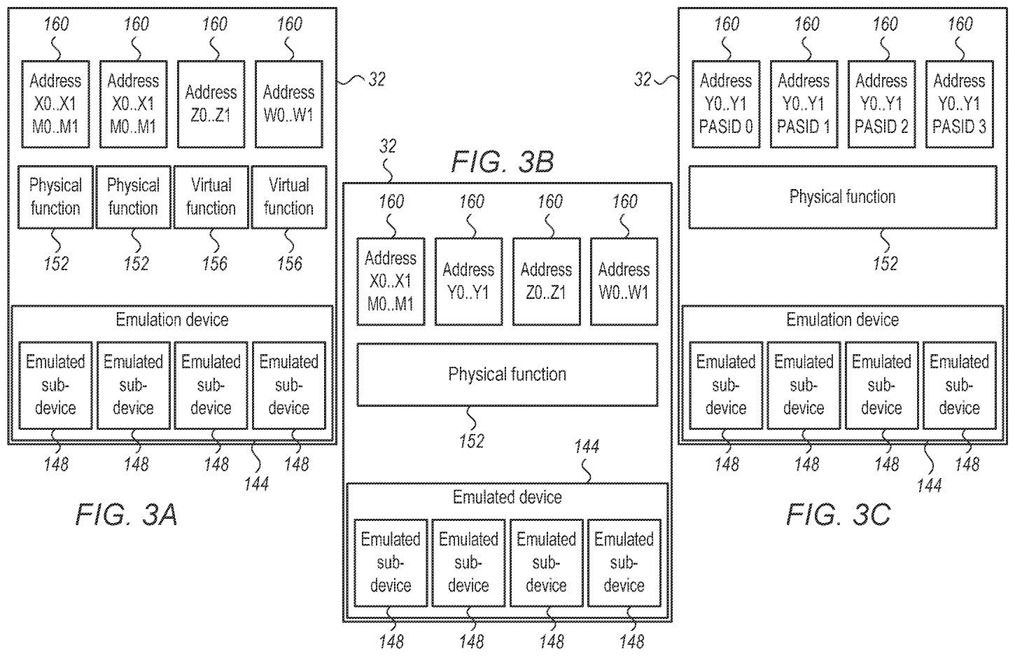

FIGS. 3A-3C are block diagrams that schematically illustrate configurations for emulation of multiple sub-devices, in accordance with embodiments of the present invention.

In the configuration of FIG. 3A, multiple emulated sub-devices 148 of a given emulated device 144 are exposed using separate PCIe functions. The PCIe functions may be physical functions 152 or virtual functions 156. Each PCIe function is accessed by accessing a respective address range (space) 160.

In the configuration of FIG. 3B, multiple emulated sub-devices 148 of emulated device 144 are exposed using a single PCIe function, in the present example a physical function 152. All PCIe transactions are received by the Same function, and a given transaction is associated to the appropriate sub-device based on the address specified in the transaction.

In the configuration of FIG. 3C, too, multiple emulated sub-devices 148 of emulated device 144 are exposed using a single physical PCIe function 152. All PCIe transactions are received by the same function. In this embodiment, a given transaction is associated to the appropriate sub-device based on the PASID specified in the transaction.

### Generic UDDI Mechanism Implementation

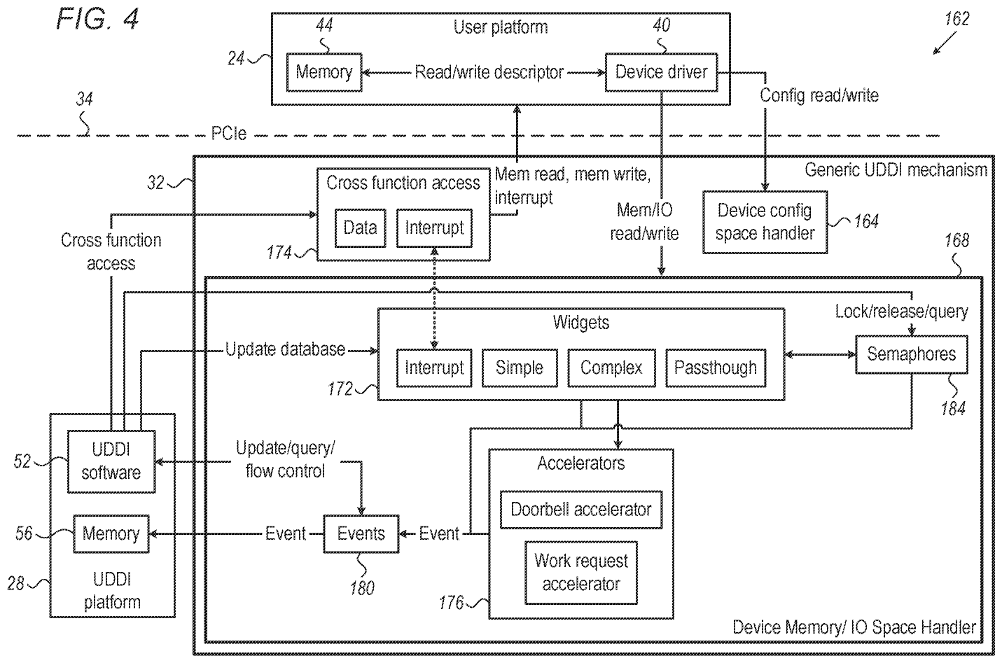

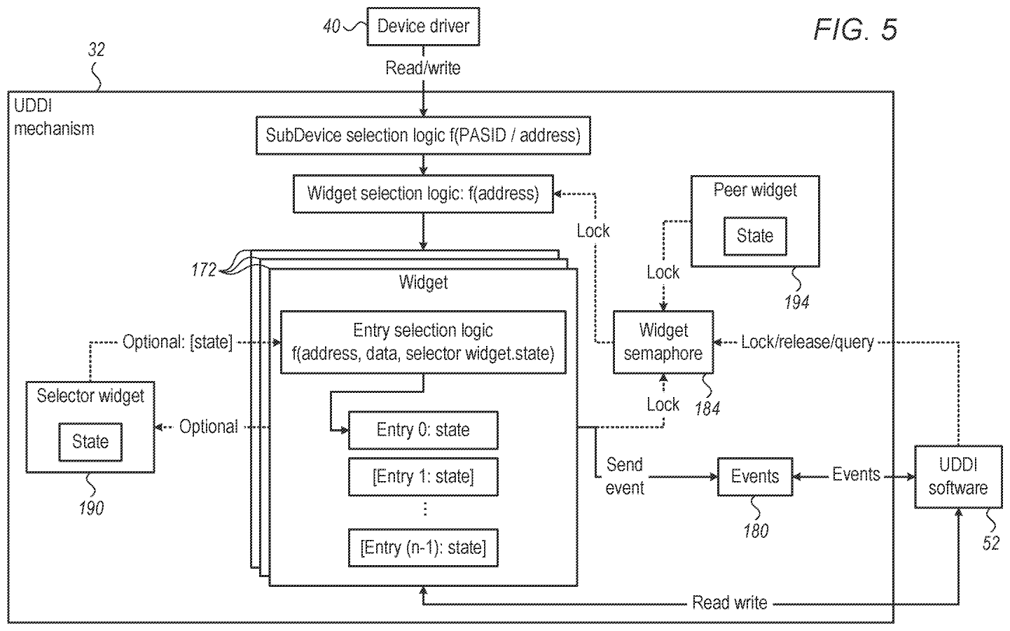

FIG. 4 is a block diagram of a computing system 162 employing UDDI, focusing on the internal structure of generic UDDI mechanism 32, in accordance with an embodiment of the present invention. In the present example, UDDI mechanism 32 comprises three major components—(i) a Configuration-Space Handler (CSH) 164, (ii) a Memory/IO-Space Handler (MISH) 168, and (iii) a Cross-Function Access (CFA) module 174. In alternative embodiments, CSH 164 and MISH 168 can be unified as a single system component. Such a unified component can use widgets to handle both inbound configuration-space read and writes and memory/IO reads and writes.

### Configuration-Space Handler (CSH)

CSH 164 is responsible for exposing the user-defined peripheral device to device driver 40 on the host, and for performing various PCIe configuration-space actions. In some embodiments, CSH 164 can be configured to expose over the PCIe bus any suitable set of configuration-space parameters, e.g., device id, vendor id, bar types and sizes, or any other suitable parameter.

In an embodiment, the user-defined device may be attached to an emulated PCIe switch (see, for example, FIG. 2D above), in which case the device can be configured as a hot-plugged device. Further aspects of PCIe switch emulation are addressed in U.S. patent application Ser. No. 17/015,424, entitled “Support for Multiple Hot Pluggable Device Via Emulated Switch,” which is assigned to the assignee of the present patent application and whose disclosure is incorporated herein by reference.

In some embodiments, the user-defined device may be configured by sending configuration-space reads and/or writes from driver 40 to CSH 164 over the PCIe bus, and having CSH 164 perform the requested configuration. In one example, an MSI vector configuration operation and/or an MSI-X function-level masking operation configures the cross-function access interrupt mechanism (elaborated further below). Another example is a Function-Level Reset (FLR) operation.

### Cross-Function Access (CFA) Module

CFA module 174 enables UDDI software 52 to perform read, write and atomic operations toward device driver 40 and memory 44, as well as other bus operations such as PCIe messages.

When using cross-function access, data-access read, write and atomic operations appear to user platform 24 (and thus to the host and in particular to the user applications that use the user-defined device) as if they originate from the user-defined device. In one example, the “requestor id” field and (optionally) the PASID field hold the requestor id and (optionally) PASID identifiers of the user-defined device (and sub-devices).

Further aspects of cross-function access are addressed in U.S. patent application Ser. No. 17/189,303, entitled “Cross Address-Space Bridging,” which is assigned to the assignee of the present patent application and whose disclosure is incorporated herein by reference.

CFA module 174 may enable cross-function access to data in host memory 40 in various ways. Some embodiments are based on synchronous load and store. In these embodiments, UDDI software 52 issues load and store commands, which are executed by CFA module 174 in host memory 44. Other embodiments are based on asynchronous Direct Memory Access (DMA). In these embodiments, CFA module 174 accesses host memory 40 using one or more dedicated DMA engines, or (when UDDI mechanism 32 is implemented in a NIC) using NIC DMA capabilities. Such DMA operations may be address based or InfiniBand key based. During data transfer, data may also be signed, encrypted, compressed or manipulated in some other manner.

In some embodiments, CFA module 174 also enables issuing interrupts that appear to user platform 24 (and thus to the host and to the user applications) as if they originate from the user-defined device. Interrupts, however, also obey the MSI-X table and configuration-space rules configured by device driver 40.

Typically, CFA module 174 issues MSI, MSI-X and/or interrupts that are compliant with the PCIe specifications. For MSI/MSI-X, for example, the interrupt parameters, masking, pending bits and other attributes are typically based on host software configuration (e.g., in device driver 40 or in the PCIe driver), for example using memory read/write and/or configuration read/write transactions. Additionally or alternatively, interrupt masking and triggering can be requested by UDDI software 52. In some embodiments, CFA module 174 also provides a mechanism for ordering writes and outbound MSI/MSI-X interrupts.

Further aspects of interrupt emulation are addressed in U.S. patent application Ser. No. 17/707,555, entitled “Interrupt Emulation on Network Devices,” which is assigned to the assignee of the present patent application and whose disclosure is incorporated herein by reference.

### Memory/IO-Space Handler (MISH)

MISH 168 handles the various read, write and atomic operations issued by device driver 40 to the memory-space and IO-space of the user-defined device. MISH 168 supports and instantiates a plurality of widgets 172 of various kinds. Each widget 172 performs a respective primitive operation that is commonly used by peripheral devices. Widgets 172 thus serve as building blocks, using which a user is able to specify any desired user-defined peripheral device. The widgets are typically stateful. At least some of the widgets can be classified into simple widgets, complex widgets and passthrough widgets. Specific examples of widgets are doorbells and work requests, which are common building blocks of peripheral devices. The structure and usage of widgets are elaborated further below.

In some embodiments MISH 168 comprises one or more hardware-implemented semaphores 184, which enable widgets to lock and release access to other widgets. In the present context, the term “locking access” means blocking access from the device driver to a certain widget until another widget releases the lock. In some embodiments MISH 168 may comprise one or more hardware-implemented accelerators 176 that accelerate the execution of certain widgets, e.g., doorbells and work requests. MISH 168 may also comprise an events module 180, which issues events to UDDI platform 28. Events may be used, for example, to trigger UDDI software 52 to complete processing of a given widget.

### Widgets—Structure, Operation and Usage

A given widget is typically invoked by an inbound PCIe transaction (e.g., TLP) from device driver 40, which accesses a respective address assigned to the widget in the address space of the user-defined device. UDDI mechanism 32 may expose addresses in the memory space and/or in the IO space and/or configuration space for use in invoking widgets (and providing them with data if appropriate).

A widget typically terminates the inbound transaction that invoked it. One exception is a passthrough widget, in which MISH 168 forwards the original Transaction-Layer Packet (TLP) received from the device driver to UDDI software 52. For non-posted transactions, such as reads and atomics, UDDI software 52 typically responds with a full completion TLP, which is forwarded to device driver 40.

Some widgets may be implemented using hardware only, e.g., entirely within UDDI mechanism 32. Other widgets may be implemented using software only. Yet other widgets may be implemented using a combination of hardware and software, e.g., with UDDI mechanism 32 triggering UDDI software 52 using a suitable event. The event typically requests the UDDI software to complete handling of the inbound transaction (e.g., read or write). Upon completion, the UDDI software may update the state of the widget.

Generally, the state of a given widget is retained in UDDI mechanism 32, and may be updated by UDDI mechanism 32 and/or by UDDI software 52. A widget state may change for various reasons, for example in response to a read, write or atomic transaction from device driver 40, and/or in response to a state update from UDDI software 52. An update to the state of a given widget may be based, for example, on data provided in a write transaction addressed to that widget. The data can be used as-is for the update, or the data may undergo manipulation such as endianness-swap or access to a lookup table, for example.

As a demonstrative example, consider a write transaction (TLP). Let X denote the data in the write transaction, i.e., TLP.data, and let Y denote an endianness-adjusted X, with either the same or converted endianness. Any of the following updates to the widget state may be performed:
ASSIGN: Widget.state=Y
Bit SET: Widget.state=widget.state |=Y
Bit CLR: Widget.state=widget.state &=˜X
ADD: Widget.state=widget.state+X

One special case is atomics—in which the widget state is updated according to the atomic opcode, e.g., Fetch and add, or compare and swap.

A given widget may be configured by mechanism 32 with various permissions, e.g., Read-Only (RO), Read-Write (RW), Write-Only (WO), Write-Combine (WC), or any other suitable permission.

A given widget may be configured by mechanism 32 to respond in various ways to illegal read access. Example responses may comprise returning a transaction error (e.g., “unsupported request”), returning fixed data (for example “0”), returning random data, or any other suitable response. Additionally or alternatively, a given widget may be configured by mechanism 32 to respond in various ways to illegal write access. Example responses may comprise returning a transaction error (e.g., “unsupported request”), ignoring the write, or any other suitable response. Further additionally or alternatively, mechanism 32 may configure a given widget to respond to an access (legal or illegal) by triggering an event towards UDDI software 52.

FIG. 5 is a block diagram of a computing system employing UDDI, focusing on widget structure and usage, in accordance with an embodiment of the present invention. In the present embodiment, UDDI mechanism 32 comprises the following components (typically in addition to the elements seen in FIG. 4):
Sub-device selection logic, for selecting a sub-device within a user-defined device by address and/or by PASID, as provided by device driver 40 in the transaction.
Widget selection logic, for selecting a widget within a given sub-device, according to the read/write address range in which the address of the transaction falls.
One or more selector widgets 190—As elaborated below.

In addition, FIG. 5 illustrates the internal structure of widgets 172, comprising multiple entries and entry selection logic. An additional feature seen in the figure is the ability to lock and release a widget using a semaphore 184, e.g., by a peer widget 194 or by UDDI software 52.

### Widget Entries

In some embodiments, a given widget 172 may comprise multiple entries, each having a separate respective state. Upon receiving a transaction destined to the widget, the entry selection logic of the widget may select the appropriate entry based on the address in the transaction, the data in the transaction and/or a state of another widget (selector widget 190 seen in FIG. 5). The following examples illustrates possible way for selecting a sub-device, a widget within the sub-device, and an entry within the widget:
Selection based on address:
   1. Address range [0x10000-0x1ffff]: indicates sub-device X.
   2. Address: 0x17230 indicates read only info widget A
Selection based on address and data:
   1. Address W: indicates that the write is a doorbell (widget type: write combining)
   2. Data: indicates which queue the doorbell is accessing (entry number)
Selection based on address and PASID:
   1. PASID indicates which sub-device the widget belongs to, address indicates the widget within the sub-device
Selection based on address and state of selector widget (S):
   1. Address A: writable selector widget (widget S) that stores queue number
   2. Address B: doorbell—entry (queue) selection is based on widget S.state

### Simple Widgets

Several non-limiting examples of simple widgets 172 are the following:
Read-Only (RO) widgets: A RO widget receives a read transaction (memory-space read, IO-space read or configuration-space read), and responds by returning a fixed data value. Typically, RO widgets do not issue events to UDDI software 52. Such widgets can be used, for example, for reading configuration parameters of a user-defined device.
Read-Write (RW) widgets: A RW widget presents a readable/writable memory range to the device driver. The memory range may be an in-device memory space, which is owned by the device driver. In such a case, the widget typically does not issue an event to the UDDI software. For large regions, the memory range will often be backed by physical memory. Alternatively, the memory range may be a device control range, e.g., for configuring device resources. In such cases the widget may issue an event to the UDDI software.
Write-Only (WO) widgets: A WO widget is typically used for issuing a command to the user-defined device. No state is maintained in the widget, and the widget is not readable. Typically, each and every write to such a widget has to be served by the device (and therefore no write combining is possible). A WO widget typically sends an event to UDDI software 52 (since the widget is stateless, the write may be irrecoverable unless reported to the UDDI software).
Write-Combine (WC) widgets: A WC widget is typically used when device driver 40 updates the state of a device, yet only the most recent value is of interest. The widget can store the latest value written thereto, or a derivation of the latest value. This feature limits the number of events needed to be issued to the UDDI software (and thuds prevents event overrun). An example of this mechanism can be device doorbells, as elaborated below.

### Widget Semaphores

Widget semaphores 184 enable one widget to lock another widget, release a lock, and/or query the state of a lock. Semaphores are useful, for example, for widgets that receive data, invoke the UDDI software to process the data, and then return a result. Another common use case is when the value set to a certain widget affects data returned by another widget. Unless such a widget is locked until the software completes processing and the result is ready, the read transaction may be performed too early and return an erroneous result.

Widget semaphores 184 have the following capabilities:
One or more widgets 172 can be locked by one or more widget semaphores 184.
One or more widgets 172 can lock a given widget semaphore 184.
Various actions may be used for triggering a lock. For example:
   The locking widget is READ from.
   The locking widget is WRITTEN to.
   The locking widget state changes, generally or for a specified bit range within the widget state.
A given widget 172 may lock, and be-locked, by the same or different widget semaphores 184.
A given widget semaphore 184 can be actuated to lock a widget explicitly by UDDI software 52.
A given widget semaphore 184 can be actuated to release a lock, explicitly by UDDI software 52. The UDDI software can either release or “release once” (e.g., allow one packet to progress).
The UDDI software can also explicitly lock a widget semaphore 184, as well as query the widget semaphore state.

In some embodiments, a widget semaphore 184 can be locked multiple times, by the same widget or by different widgets. In one embodiment, the UDDI mechanism counts the number of locks, and requires a similar number of releases in order to actually release the lock. In another embodiment, a single release will unlock the semaphore regardless of the number of times it has been locked.

Once a semaphore has locked a widget, subsequent read and/or write accesses to the locked widget will be queued until receiving a semaphore release indication for the UDDI software. A widget semaphore can be configured to issue an event upon locking, and/or upon packet arrival (pending semaphore release).

### Events Mechanism

As noted above, events are part of the interface between UDDI mechanism 32 and UDDI software 52. An event is typically generated by a given widget 172 in order to trigger UDDI software 52 to complete the widget processing. Events are managed by events module 180 (seen in both FIGS. 4 and 5).

In some embodiments, the event mechanism comprises the following interfaces and features:
Event trigger: A widget may be configured to issue an event towards the UDDI software upon any suitable trigger, such as:
   Upon memory/IO/config read and/or write and/or atomic operation.
   Upon memory/IO/config write or atomic that modifies the value of one or more given bits within the widget state.
Event query: UDDI software 52 may retrieve information contained in a given event. The information may be written to memory associated with the UDDI software (“push”), or stored within the UDDI mechanism (“pull”). A given user-defined device may use push events, pull events or both.
Interrupt mechanism. An optional mechanism that enables events module 180 to trigger UDDI software 52 to handle an event. Alternatively, the UDDI software may intermittently read (“poll”) memory mapped to the UDDI mechanism for event indications. UDDI mechanism 32 may comprise a single interrupt mechanism for all widgets, or multiple interrupt mechanisms for respective groups of widgets.
Flow control mechanism: An optional mechanism used in conjunction with “push” event querying. When using “push” event querying, some form of flow control is needed in order not to overrun the UDDI software resources. Once UDDI software 52 has handled the event, it sends a flow control indication back to the UDDI mechanism to allow additional events to be triggered. UDDI mechanism 32 may comprise a single flow control mechanism for all widgets, or multiple flow control mechanisms for respective groups of widgets. Flow control indications may be credit-based, acknowledgement (ACK) and/or Negative ACK (NAK) based, pause-resume (“backpressure”) based, or any other.

Following receipt of an event, UDDI software 52 may retrieve the following data, for example:
Widget and entry being accessed (and/or the original memory/IO/config address and other selection parameters).
Opcode: Read/write/atomic operation, or other.
Access size
Data, e.g., transaction data, and/or state of the widget originating the event, and/or state of additional widgets.

### Complex Widgets

Complex widgets provide richer functionality than the simple widgets described above. Complex widgets can be implemented as standalone widgets, or they can utilize one or more of the simple widgets described above with a simple set of configurations (e.g., widget type, event, semaphore configurations, etc.) that together provide higher level functionality. Several non-limiting examples of complex widgets are given below.

Default widget: A widget that is invoked by access to an address for which no device behavior is defined. The default widget typically has no read, write or atomic permissions. The default widget may be configured to return a constant value, to generate an “unsupported request” error message, to move the user-defined device to an error state, or to perform any other suitable action.

Blocking read widget: In some cases, the UDDI software is required to explicitly generate a response to a read transaction. In such a case, a “blocking read” widget may be used to delay completion notification over the PCIe bus until the UDDI software provides the necessary data. The blocking read widget can be implemented using the following:
A RO widget connected to a semaphore.
UDDI software 52 initializes the semaphore as locked.
The semaphore is configured to issue an event on packet arrival.
The UDDI software receives the event, updates the widget state, and performs a release-once of the semaphore.

Read with Lazy Update (RLU) widget: A widget that reads the internal database and sends an update-request even to the UDDI software. This widget is useful, for example, when an user-defined device asynchronously signals work completion, error, or state update. In some embodiments, device driver 40 intermittently reads relevant addresses for state update and invokes the widget. From a system perspective, this widget is useful when readout of stale data is harmless, as long as state eventually propagates from the user-defined device. The LRU widget completes the memory/IO/Config read immediately using current widget state (without delaying the completion notification over the PCIe bus), and then sends a notification to the UDDI software to update the state. This feature is especially useful when generation of a response is slow, which could result in a PCIe timeout from the user platform's perspective. The LRU widget can be implemented by using a RO widget configured to issue an event on read request.

Externally-selected multi-entry widget: Devices often expose a large logical memory space using a narrow physical aperture on the device's PCIe Base Address Register (BAR). This is often performed by selecting the logical address space on address A (e.g., by writing value X representing logical address X). Accesses to physical address B are then redirected to the logical access X. This operation can be implemented using a pair of widgets:
A selector widget that holds a single state (a number between 0 and X−1).
A multi entry widget: A single RW widget whose state comprises multiple entries (0 . . . X−1). Entry selection in this widget is based on the selector widget.

Snapshot widget: A user-defined device is often configured by writing a large group of registers (represented by different widgets), followed by a write to an “enable” field. In some cases, the data written to the data registers may not be available after writing the enable, since the device driver will immediately commence with another set of configurations. A solution to this problem can be a “snapshot” complex widget. This widget comprises multiple data widgets that aggregate data written by the device driver, and an “enable” widget. When the device driver writes to the “enable” widget, state from all the data widgets will be aggregated into a single event and issued to the UDDI software. At that stage, the device driver can safely overwrite the state contained in the data widgets.

Doorbell widget: A doorbell is a mechanism used by device driver 40 to inform a user-defined device that work is pending. Work indication granularity may be per-device, per-object or per work request, for example. A common configuration is for the work to be arranged in a queue or ring format, and for a doorbell to indicate that work is pending on this queue. This configuration allows an expansion of the generic doorbell handling to include work request handling. In the description that follows, the object the widget is bound to is referred to as a queue. Doorbell widgets will often be Write-Combine (WC) widgets. Generally, however, doorbell widgets may also be write-only or read/write widgets. Since doorbells are often received at high rates, device interfaces may be defined so as to be able to recover queue state from device driver memory. As this is the case, a non-write combining widget can be configured as follows: Once more than a configurable number of doorbells have been queued and not handled, doorbell is dropped, and a recovery event is sent to the UDDI software, indicating recovery is required for a specified group of queues.

### Passthrough Widgets

A TLP passthrough widget issues the entire TLP, as it is received from the device driver, as an event to the UDDI software. For non-posted TLPs, the UDDI software generates an entire completion TLP and injects it to the widget mechanism. Passthrough widgets provide the ability to implement an entire PCIe device in the UDDI software.

In an alternative embodiment, instead of receiving the entire TLP, UDDI software 52 receives only a subset of TLP information, and MISH 168 maintains some of the state. For example, to perform a read, UDDI software 52 may receive the opcode, the address, the data, etc. Some fields such as tag or relaxed order, however, can be maintained by MISH 168. Once software 52 pushes a completion, MISH 168 uses the recorded PCIe properties to generate a full completion TLP.

### Widget Interrupt Handling

In various embodiments, UDDI mechanism 32 may handle widget interrupts in various ways. Handling is typically different for different interrupt types.

MSI-X: The PCIe specification defines an MSI-X table/PBA configuration over the device's memory space. Since reading the MSI-X table is assumed to have flushed outstanding MSI-X interrupts, the widget circuitry handling the MSI-X table is directly connected to the interrupt handler of Cross-Function Access (CFA) module 174 (see dashed arrow in FIG. 4). The precise handling of these transactions is in accordance with the PCIe specification.

MSI/vendor-specific interrupts: Some devices support MSI, as specified in the PCIe specifications. Some devices provide a vendor specific way to mask and unmask interrupts, and/or to configure address and data associated with interrupts. By connecting to the interrupt handler of CFA 174, UDDI mechanism 32 enables widgets 172 to be configured so as to perform these operations.

Legacy interrupts: Some devices provide a way (specified in PCIe or vendor specific, using wires or message-emulated) to assert and de-assert interrupts, and/or to query the state of an interrupt (asserted/de-asserted). By connecting to the interrupt handler of CFA 174, UDDI mechanism 32 enables widgets 172 to be configured so as to perform these operations.

### Doorbell Accelerator

As described above, most of doorbell handling is carried out by suitable widgets 172. One exception, in some embodiments, is doorbell error handling. A given doorbell may comprise a “producer index” indicating how much work has been requested from the device. In some cases, device behavior may require checking that the producer index is within a configurable range (e.g., queue size), or that the current value of the producer index is greater or equal than a previous value.

Checking that the current value of the producer index is greater or equal than a previous value may need to take a variable width into account (e.g., the queue size or other arbitrary size width, such as sixteen bits). When this error state occurs, an event can be issued to UDDI software 52. In some embodiments, doorbell error handling, including the above-described check and response, is carried out by a doorbell accelerator (part of accelerators 176 see in FIG. 4).

### Work Request Accelerator

As noted above, doorbells are often associated with a queue or ring structure. As such, it is possible to define a generic work request extraction logic. In some embodiments, such generic logic is carried out by a work request accelerator (part of accelerators 176 see in FIG. 4).

Typically, each queue holds parameters such as a base address (as well as requestor ID and PASID affiliation), the number of buffered entries, entry size and the like. In a typical generic logic, when a doorbell arrives, a corresponding queue is selected. The last producer index is then extracted and updated (as described above with respect to the doorbell widget). The work request handler then calculates the next entry to be read, reads the entry/entries and issues an event to the UDDI software. Entries can be configured to be sent one by one, or a group of entries can be issued as a single event.

### Device Initialization, Teardown, and Error State

In some embodiments, generic UDDI mechanism 32 allows a certain degree of decoupling between UDDI software 52 and the exposure of the user-defined PCIe device towards user platform 28. Several examples of this feature are outlined below.

Static vs. dynamic configuration: Device implementation can either be configured statically or dynamically. When using static configuration, UDDI mechanism 32 is already pre-loaded at boot time with the necessary information in order to expose a user-defined device. Since UDDI software 52 may not be loaded at the time, generic UDDI mechanism 32 is typically configured to provide the necessary subset of device functionality. When using dynamic configuration, in an embodiment, UDDI mechanism 32 is configured at boot time to only expose a user-defined PCIe switch with no attached devices. The generic UDDI mechanism capable of attaching a software-defined device (emulation of a hot-plug of user-defined device) by attaching it to the user-defined PCIe switch during run-time. The generic UDDI mechanism provides an interface for the UDDI software to perform this configuration. Similarly, UDDI software 52 can also cause UDDI mechanism 32 to dynamically hot-unplug a user-defined device, and then attach the same or different device to the same user-defined PCIe switch port.

Generic UDDI behavior for unavailable UDDI software: In some cases, UDDI software 52 may be unavailable, e.g., because UDDI platform 28 is down due to error, reset or during boot. In such cases, generic UDDI mechanism 32 is typically still capable of performing tasks such as PCIe device discovery, some basic PCIe compliant device operation, and, when relevant, provide device-specific indications that the device is not ready to be initialized or is in an error state.

Function Level Reset (FLR): To perform FLR, device driver 40 issues an explicit request to reset the state of the user-defined device. Upon receiving this configuration request, generic UDDI mechanism 32 notifies UDDI software 52, in order to reset the user-defined device state. In parallel, generic UDDI mechanism 32 ceases any outbound DMA access by the user-defined device. For example, outbound cross device posted transactions are typically dropped. As another example, outbound cross device non-posted transactions can be configured to return a constant value (e.g., zero), to return an “unsupported request”, or to trigger a timeout.

The configurations of the various computing systems and UDDI systems described herein, and their various components, such as the various user platforms, UDDI platforms and generic UDDI mechanisms, as depicted in FIGS. 1-5, are example configurations that are chosen purely for the sake of conceptual clarity. Any other suitable configurations can be used in alternative embodiments. In various embodiments, the various computing systems and UDDI systems described herein, and their various components, such as the various user platforms, UDDI platforms and generic UDDI mechanisms, can be implemented using hardware, e.g., using one or more Application-Specific Integrated Circuits (ASIC) and/or Field-Programmable Gate Arrays (FPGA), using software, or using a combination of hardware and software components.

In some embodiments, at least some of the functions of the disclosed system components, e.g., some or all functions of the user platform (e.g., device driver) and/or UDDI platform (e.g., UDDI software), are implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

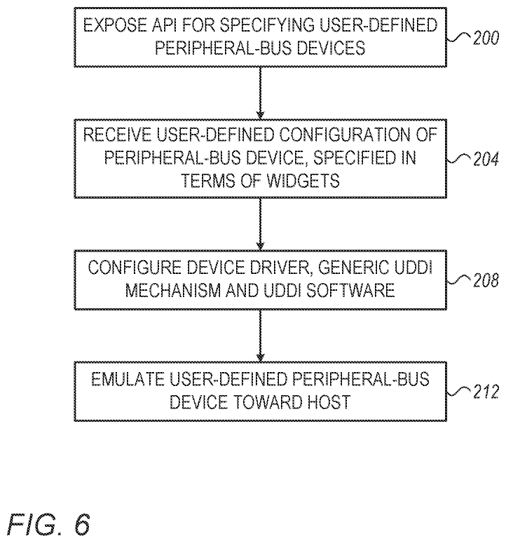

FIG. 6 is a flow chart that schematically illustrates a method for UDDI, in accordance with an embodiment of the present invention. The method begins at an API exposure stage 200, with UDDI platform 28 or user platform 24 exposing an API for specifying user-defined peripheral-bus devices. As explained above, the API enables a user to specify any desired business logic of any desired peripheral device, in terms of a plurality of supported widgets.

At a definition input stage 204, the UDDI platform or user platform receives a user-defined configuration of a peripheral-bus device to be implemented (e.g., emulated). At a configuration stage 208, the user platform (and specifically the device driver), UDDI platform and generic UDDI mechanism are configured to implement the peripheral-bus device in accordance with the user-defined configuration. Typically, the user platform discovers the emulated device, and the device driver loads. The UDDI platform and the generic UDDI mechanism are typically configured by software running on the UDDI platform.

At an emulation stage 212, the user platform, UDDI platform and generic UDDI mechanism emulate the device in question toward the user application or applications.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a bus interface, configured to communicate with an external device over a peripheral bus; and
circuitry, configured to:
support a plurality of widgets that perform primitive operations used in implementing peripheral-bus devices;
receive a user-defined configuration, which specifies a user-defined peripheral-bus device as a configuration of one or more of the widgets; and
implement the user-defined peripheral-bus device toward the external device over the peripheral bus, in accordance with the user-defined configuration.

2. The system according to claim 1, wherein the external device is a host or a peer device coupled to the host.

3. The system according to claim 1, wherein the user-defined peripheral-bus device is one of:
a network adapter;
a storage device;
a Graphics Processing Unit (GPU); and
a Field Programmable Gate Array (FPGA).

4. The system according to claim 1, wherein the circuitry is configured to implement the user-defined peripheral-bus device by software emulation.

5. The system according to claim 1, wherein the widgets are configured to be invoked by the external device accessing respective addresses that are assigned to the implemented user-defined peripheral-bus device in an address space of the peripheral bus.

6. The system according to claim 5, wherein the address space comprises a configuration space, and wherein the circuitry comprises a handler for handling accesses of the external device to the configuration space that configure the implemented user-defined peripheral-bus device.

7. The system according to claim 5, wherein the address space comprises a memory space, and wherein the circuitry is configured to invoke the widgets in response to the external device accessing addresses in the memory space.

8. The system according to claim 5, wherein the address space comprises an Input/Output (I/O) space, and wherein the circuitry is configured to invoke the widgets in response to the external device accessing addresses in the I/O space.

9. The system according to claim 1, wherein the widgets are configured to be invoked by the external device accessing one or more message types over the peripheral bus.

10. The system according to claim 1, wherein the circuitry is configured to access a memory of the external device on behalf of the implemented user-defined peripheral-bus device in accordance with the user-defined configuration.

11. The system according to claim 1, wherein the circuitry is configured to issue interrupts on the peripheral bus on behalf of the implemented user-defined peripheral-bus device, in accordance with the user-defined configuration.

12. The system according to claim 1, wherein:
the circuitry comprises (i) user-defined peripheral-bus device implementation (UDDI) hardware and (ii) a processor that runs user-defined peripheral-bus device implementation (UDDI) software, and
a given widget is configured to perform a primitive operation by (i) performing a front-end part of the primitive operation using the UDDI hardware, and (ii) triggering the UDDI software to perform a back-end part of the primitive operation.

13. The system according to claim 12, wherein the UDDI hardware is configured to issue an event to the UDDI software upon completing the front-end part of the primitive operation, and wherein the UDDI software is configured to update a state of the given widget upon completing the back-end part of the primitive operation.

14. The system according to claim 1, wherein the circuitry comprises a configurable semaphore for enabling a first widget to lock and release a second widget in accordance with the user-defined configuration.

15. The system according to claim 14, wherein the first widget and the second widget are a same widget.

16. The system according to claim 14, wherein the semaphore is releasable by software or hardware.

17. The system according to claim 1, wherein the circuitry comprises a hardware accelerator configured to accelerate the widgets of a given type.

18. The system according to claim 1, wherein at least a given widget is specified in terms on one or more other widgets in the plurality.

19. The system according to claim 1, wherein the widgets comprise one or more of the following widget types:
a passthrough widget that forwards a transaction packet, received over the peripheral bus, for handling by software;
a widget implementing a doorbell;
a widget implementing a work request;
a read-only widget;
a write-only widget;
a read-write widget; and
a write-combine widget.

20. A method, comprising:
communicating with an external device over a peripheral bus;
supporting a plurality of widgets that perform primitive operations used in implementing peripheral-bus devices;
receiving a user-defined configuration, which specifies a user-defined peripheral-bus device as a configuration of one or more of the widgets; and
implementing the user-defined peripheral-bus device toward the external device over the peripheral bus, in accordance with the user-defined configuration.
